(19) United States
(12) Patent Application Publication
(10) Pub. No.: US 2006/0222819 A1
(43) Pub. Date: Oct. 5, 2006

(54) Multilayer paper

(76) Inventor: Giovanni Gambini, Pisa (IT)

Correspondence Address: HEDMAN & COSTIGAN P.C., 1185 AVENUE OF THE AMERICAS, NEW YORK, NY, 10036, US

(21) Appl. No.: 11/378,967

(22) Filed: Mar. 17, 2006

(30) Foreign Application Priority Data
Apr. 4, 2005 (IT) MI2005A 000554

(51) Int. Cl. B32B 3/00

(52) U.S. Cl. 428/172

(57) ABSTRACT

Multilayer paper (10) comprising at least two layers, overlapped and bound to each other by means of adhesive material (60) interposed between the same in small quantities, of which at least one layer of the at least two layers is a micro-embossed layer having a density of small protuberances/cm² greater than 70 protuberances/cm².

The present invention refers to a multilayer paper which may be used as toilet paper and/or as paper for household use, in particular as absorbent paper.

The present invention refers in particular to a multilayer paper with two layers or more layers joined together by means of adhesive material to form a multilayer toilet paper.

Presently, the need is quite requested for toilet paper and/or kitchen paper to be increasingly smooth and soft and at the same time equipped with a certain mechanical strength.

Presently, there exist realisation methods of multiple layer toilet paper based on a technique of drying through a flow of hot air, commonly known by the English acronym TAD, which however presents the drawback of a high production cost.

Object of the present invention is that of realising a multilayer paper which is economical.

Another object is that of realising a multilayer paper which is smooth to the touch and soft.

Another object of the present invention is that of realising a multilayer paper which is smooth and which has a good mechanical strength.

Further object is that of being able to have multilayer paper which is smooth to the touch, which has a good mechanical strength, and which is at the same time economical.

These objects according to the present invention are achieved by realising a multilayer paper as set forth in claim 1.

Further characteristics of the invention are outlined by the subsequent claims.

The characteristics and advantages of a multilayer paper according to the present invention are made clearer from the following exemplifying and not limiting description, referred to the attached schematic drawings in which:

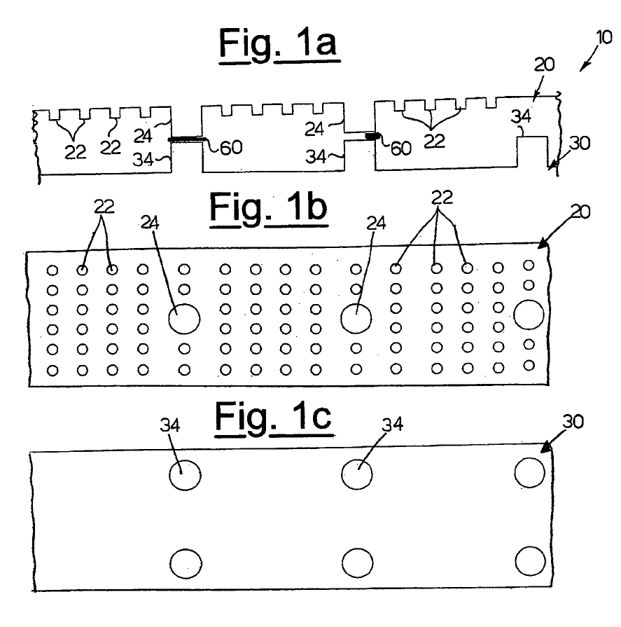

FIGS. 1a-1c are schematic views of a multilayer paper according to a first embodiment of the invention in which FIG. 1a is a longitudinal section view of a two-layer product and FIGS. 1b and 1c are schematic views which show a top plan view of the outer layer and the inner layer;

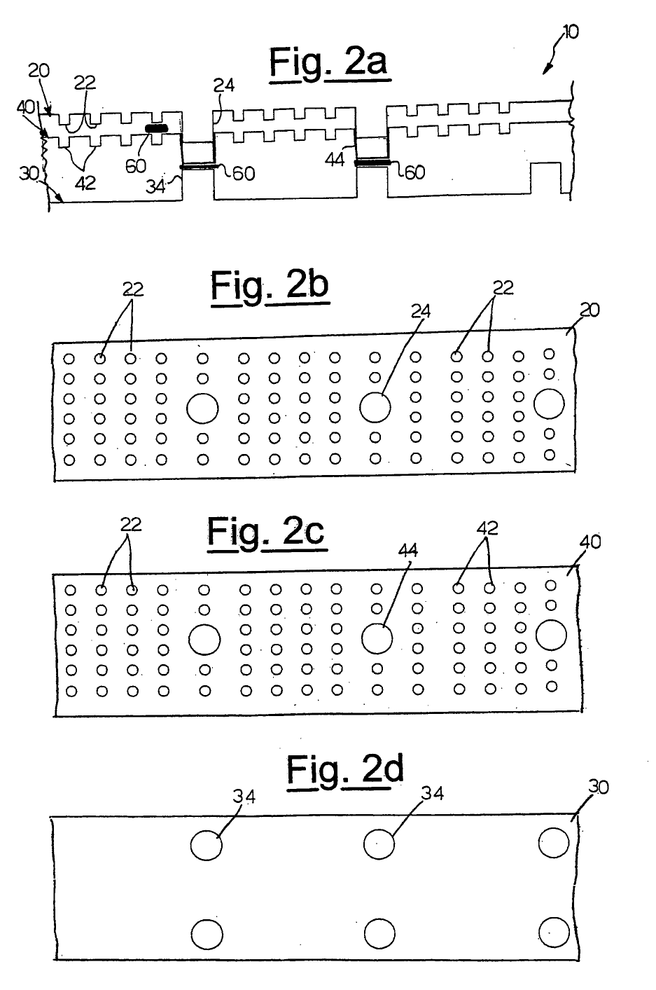

FIGS. 2a-2d show schematic views of a multilayer paper according to a second embodiment of the invention in which FIG. 2a is a longitudinal section view of a three-layer product and FIGS. 2b-2d are schematic views which show a top plan view of the outer layer, the intermediate layer and the inner layer.

With reference to the figures, a multilayer paper 10 is shown comprising at least two layers, joined together by means of adhesive material 60 interposed in small quantities between the same, and of which at least one layer of said at least two layers is micro-embossed.

Said at least one micro-embossed layer has in particular a plurality of small protuberances 22, distributed and uniformly spaced from each other, with a density greater than 70 protuberances/cm², preferably greater than 90 protuberances/cm² and still more preferably greater than 110 protuberances/cm².

In this manner, it is possible to have a very economical multilayer paper and at the same time equipped with a high pleasantness to the touch, at least on one side of the same.

In other terms, the multilayer paper 10 therefore has a roughness similar to that obtainable through drying the paper by means of a hot air jet, or rather very similar to the paper obtainable with the TAD technology, and at the same time with decidedly lower costs.

Preferably, said at least one micro-embossed layer is at least two micro-embossed layers, or rather the multilayer paper comprises at least two layers which are preferably micro-embossed.

This so to have a micro-rough outer surface, such to result as a non-fabric fabric-type paper.

Preferably, said at least one micro-embossed layer also comprises a macro-embossed portion, or rather a portion having a plurality of large protuberances present with a density of less than 30 protuberances/cm².

This in order to be able to define a clearly visible embossed motif or design on the multilayer paper 10.

In particular, the macro-embossed portion may have a height of the large protuberances 24 different from the micro-embossed portion.

This in order to increase the smoothness and thickness of the multilayer paper 10, in particular in the case of use as toilet paper.

According to a first embodiment shown in FIGS. 1a-1c, a multilayer paper 10 is provided comprising a first outer layer 20 and a second inner layer 30, joined by means of adhesive material 60 interposed in small quantities between the same.

Preferably, said first layer 20 and/or said second layer 30 are micro-embossed.

Preferably, said first outer layer 20 and/or second inner layer 30 are also macro-embossed.

Preferably, said first layer 20 and/or said second layer 30 comprise designs.

According to an additional aspect of the present invention, a multilayer paper 10 is provided comprising at least three layers of which at least two adjacent layers have a micro-embossed surface.

Preferably, said at least two adjacent layers are directly overlapped and coupled together, and at the same time said at least two adjacent layers are micro-embossed with a plurality of small protuberances having a density greater than 70 protuberances/cm².

Still more preferably, said at least two layers are identical and are coupled together so to perfectly couple the large and/or small protuberances of one layer respectively with the large and/or small protuberances of the adjacent layer.

In particular, according to a further preferred embodiment, shown in FIGS. 2a-2d, a multilayer paper 10 is provided comprising a first outer layer 20, a second inner layer 30 and a third intermediate layer 40 joined by means of adhesive material 60 interposed between the layers themselves.

In particular, the first outer layer 20 and the third intermediate layer 30 may be coupled together, or else the second inner layer 30 and the third intermediate layer 40 may be coupled together.

Said at least two adjacent and coupled layers are both micro-embossed with a density of protuberances greater than 70 protuberances/cm².

Preferably, said first layer 20 and/or said second inner layer 30 comprise a plurality of small protuberances 22 or 32 and/or a plurality of large protuberances 24 or 34.

The plurality of small protuberances 22 and 32 is in particular present with a density greater than 70 protuberances/cm², preferably greater than 90 protuberances/cm², and still more preferably greater than 110 protuberances/cm².

The plurality of large protuberances 24 and 34 have in particular a density less than 30 protuberances/cm².

The intermediate layer 40 in this case is identical to the first outer layer 20 and therefore has a density of small protuberances 42 greater than 70 protuberances/cm².

Alternatively, the intermediate layer may be different but in any case micro-embossed with a density of small protuberances 42 greater than 70 protuberances/cm².

Modifying the weight of the multilayer paper and the quantity of adhesive to bind the first layer 20 to the second layer 30 and additional layers, it is possible to obtain a multilayer paper which may be used as toilet paper or as paper for household uses.

In particular, the weight of the multilayer paper is greater than 14 g/m².

It is thus seen that a multilayer paper according to the present invention realises the objects outlined above.

The multilayer paper of the present invention thus conceived is susceptible to numerous modifications and variations, all coming under the same inventive concept.

Furthermore, in practice, the materials used, as well as their dimensions and components, may be of any type according to the technical needs.

1. Multilayer paper (10) comprising at least two layers, overlapped and bound to each other by means of adhesive material (60) interposed between the same in small quantities, characterised in that at least one layer of said at least two layers is a micro-embossed layer having a density of small protuberances/cm² greater than 70 protuberances/cm².

2. Multilayer paper (10) according to claim 1, characterised in that said at least one micro-embossed layer has a density of small protuberances/cm² (22) greater than 90 protuberances/cm².

3. Multilayer paper (10) according to claim 1, characterised in that said at least one micro-embossed layer has a density of small protuberances/cm² (22) greater than 110 protuberances/cm².

4. Multilayer paper (10) according to claim 1, characterised in that said at least one micro-embossed layer is at least two micro-embossed layers.

5. Multilayer paper (10) according to claim 4, characterised in that said two micro-embossed layers are two adjacent layers, directly overlapped and coupled to each other.

6. Multilayer paper (10) according to claim 1, characterised in that said at least one micro-embossed layer comprises a plurality of large protuberances present with a density less than 30 protuberances/cm².

7. Multilayer paper (10) according to claim 1, characterised in that it comprises a first outer layer (20) and a second inner layer (30), joined together by means of adhesive material (60) interposed in small quantities between the same.

8. Multilayer paper (10) according to claim 7, characterised in that said first layer (20) and/or said second layer (30) are micro-embossed.

9. Multilayer paper (10) according to claim 7, characterised in that said first outer layer (20) and/or said second inner layer (30) comprise a macro-embossed portion.

10. Multilayer paper (10) according to claim 7, characterised in that said first layer (20) and/or said second layer (30) comprise designs.

11. Multilayer paper (10) according to claim 7, characterised in that it comprises an intermediate layer (40).

12. Multilayer paper (10) according to claim 1, characterised in that at least two adjacent layers present a micro-embossed surface.

13. Multilayer paper (10) according to claim 12 characterised in that said at least two adjacent layers are directly overlapped and coupled with each other, and at the same time said at least two adjacent layers are micro-embossed with a plurality of small protuberances having a density greater than 70 protuberances/cm².

14. Multilayer paper (10) according to claim 12, characterised in that said at least two layers are identical and are coupled together so to perfectly couple together the large and/or small protuberances of one layer with the large and/or small protuberances of the other adjacent layer.

15. Multilayer paper (10) according to claim 13, characterised in that said at least two layers are identical and are coupled together so to perfectly couple together the large and/or small protuberances of one layer with the large and/or small protuberances of the other adjacent layer.
